(19) United States
(12) Patent Application Publication
(10) Pub. No.: US 2011/0187734 A1
(43) Pub. Date: Aug. 4, 2011

(54) IMAGE DISPLAY APPARATUS AND CONTROL METHOD FOR IMAGE DISPLAY APPARATUS

(75) Inventor: Hideaki Yui, Machida-shi (JP)

(73) Assignee: CANON KABUSHIKI KAISHA, Tokyo (JP)

(21) Appl. No.: 13/012,241

(22) Filed: Jan. 24, 2011

(30) Foreign Application Priority Data
Feb. 3, 2010 (JP) 2010-021939

(51) Int. Cl. G09G 5/02; G09G 5/39

(52) U.S. Cl. 345/589; 345/531

(57) ABSTRACT

An image display apparatus includes: a display panel; a first storage unit that stores correction data; a second storage unit; a transfer unit that transfers the correction data from the first storage unit to the second storage unit; a correction unit that implements the correction processing on an input video signal while referencing the second storage unit; and a control unit, wherein the control unit performs control such that when a part of the correction data has been stored in the second storage unit, interim correction processing using the part of the correction data is started and video display is begun, and after a remainder of the correction data has been stored in the second storage unit, the correction processing performed is switched to correction processing using all of the correction data.

### BACKGROUND OF THE INVENTION

1. Field of the Invention

The present invention relates to an image display apparatus and a control method for the image display apparatus.

2. Description of the Related Art

Conventional techniques relating to image display apparatuses are disclosed in Japanese Patent Application Laid-open No. 2007-104083 and Japanese Patent Application Laid-open No. 2008-187379, for example.

Japanese Patent Application Laid-open No. 2007-104083 discloses a technique for allowing a user to recognize that a activation operation is being transmitted to a machine by displaying a predetermined still image or moving image on a screen between execution of the activation operation and the start of normal display.

Japanese Patent Application Laid-open No 2008-187379 discloses a technique for reducing an apparent processing time by displaying a narrow band broadcast prior to a broadband broadcast that requires a long processing time to be displayed.

### SUMMARY OF THE INVENTION

Image display apparatuses such as liquid crystal display apparatuses (LCD), plasma display apparatuses (PDP), field emission display apparatuses (FED), and organic EL display apparatuses (OLED) are available as flat panel display apparatuses (FPD).

In these FPDs, a large number of display elements must be formed on a substrate. A light emission characteristic of the display elements is affected by slight differences in manufacturing conditions and so on. Therefore, it is typically difficult to make the light emission characteristics of all of the display elements provided in the FPD perfectly uniform. Unevenness in the light emission characteristic causes brightness variation, leading to deterioration of an image quality. In the case of an FED, for example, surface conduction type electron-emitting devices, Spindt type electron-emitting devices, MIM type electron-emitting devices, and carbon nanotube type electron-emitting devices are used as electron-emitting devices. When differences occur in a shape or the like of the electron-emitting devices due to differences in the manufacturing conditions of the electron-emitting devices and so on, variation occurs in an electron emission characteristic of the electron-emitting devices. As a result, brightness variation occurs, leading to deterioration of the image quality.

In response to this problem, a constitution for correcting a video signal in accordance with the light emission characteristic of each display element has been proposed (brightness variation correction). For example, in one method, correction data including an adjustment ratio (a correction value) for reducing brightness variation are prepared in advance for each display element and the brightness variation is reduced by multiplying the adjustment ratio by an input video signal. However, the brightness variation may be dependent on a gradation value (the variation may be gradation-dependent). Therefore, to reduce brightness variation with regard to all gradation values, correction values corresponding to the respective gradation values must be prepared for each display element, leading to a massive increase in the volume of the correction data. This volume increases even further in accordance with increases in the definition of the image display apparatus.

Meanwhile, the correction data must be stored even when a power supply of the image display apparatus is disconnected, and therefore the correction data are typically held in a non-volatile memory such as a flash memory. Further, since a non-volatile memory operates at a lower speed than a processing rate of video processing, the correction data must be transferred from the non-volatile memory to a high-speed volatile memory such as DRAM for brightness variation correction every time the power supply of the image display apparatus is connected. A resulting increase in transfer volume (the aforementioned correction data volume) leads to increases in a transfer time, an activation time of the image display apparatus (a time required to display a video), and an activation time of a digital television set or the like to which the image display apparatus is applied.

In response to this problem, several methods for reducing the activation time may be considered.

One method is to reduce the volume of correction data or compress the correction data. However, when the correction data volume is reduced, a post-correction image quality (a degree by which brightness variation is reduced) decreases dramatically, and therefore this method is nut suitable. Furthermore, brightness variation is typically random, and therefore a correlativity of the correction data is low, making it impossible to achieve an improvement in compressibility.

In another method, a transfer speed is increased by performing parallel processing using a plurality of non-volatile memories. However, this method is extremely expensive and therefore not suitable.

Further, the techniques disclosed in Japanese Patent Application Laid-open No. 2007-104033 and Japanese Patent Application Laid-open No. 2008-187379 are both techniques for favorably reducing an activation time generated by decoding of a broadcast signal or the like rather than techniques for reducing an activation time generated by the transfer of correction data. Therefore, an activation time generated by the transfer of correction data cannot be shortened when the techniques disclosed in Japanese Patent Application Laid-open No. 2007-104083 and Japanese Patent Application Laid-open No. 2008-187379 are employed.

The present invention provides a technique for displaying a video exhibiting reduced brightness variation in a short amount of time.

A first aspect of the present invention is an image display apparatus including: a display panel having a plurality of display elements disposed in a matrix form;

a first storage unit that stores correction data used in correction processing for reducing brightness variation among the plurality of display elements;

a second storage unit used as a work memory;

a transfer unit that transfers the correction data from the first storage unit to the second storage unit;

a correction unit that implements the correction processing on an input video signal while referencing the second storage unit; and

a control unit,

wherein the control unit performs control such that when a part of the correction data has been stored in the second storage unit by the transfer unit, interim correction processing using the part of the correction data is started by the correction unit and video display on the display panel is begun, and after a remainder of the correction data has been stored in the second storage unit by the transfer unit, the correction processing performed by the correction unit is switched to correction processing using all of the correction data.

A second aspect of the present invention is an image display apparatus including: a display panel having a plurality of display elements disposed in a matrix form;

a first storage unit that stores correction data used in correction processing for reducing brightness variation among the plurality of display elements;

a second storage unit used as a work memory;

a transfer unit that transfers the correction data from the first storage unit to the second storage unit;

a correction unit that implements the correction processing on an input video signal while referencing the second storage unit; and

a control unit,

wherein the control unit performs control such that when transfer of the correction data begins, display of a video based on a predetermined video signal that has been subjected in advance to the correction processing for reducing the brightness variation is started, and after transfer of the correction data has begun, correction processing using the transferred correction data is started by the correction unit.

According to the present invention, a video exhibiting reduced brightness variation can be displayed in a short time.

Further features of the present invention will become apparent from the following description of exemplary embodiments with reference to the attached drawings.

### BRIEF DESCRIPTION OF THE DRAWINGS

FIG. 1 is a view showing an example of a flow of processing performed by a system control unit according to a first embodiment;

FIG. 2 is a view showing an example of the overall constitution of an image display apparatus according to this embodiment;

FIG. 3 is a view showing an example of a modulation signal;

FIG. 4 is a view showing an example of a characteristic of an electron-emitting device;

FIG. 5 is a view showing an example of gradation dependency of a correction value;

FIG. 6 is a view showing an example of the constitution of a brightness variation correction unit according to this embodiment;

FIGS. 7A and 7B are views showing a flow of processing performed by a conventional system control unit;

FIGS. 8A and 8B are views showing a conventional startup sequence;

FIG. 9 is a view showing an example of a startup sequence according to the first embodiment;

FIG. 10 is a view showing an example of a flow of processing performed by a system control unit according to a second embodiment;

FIG. 11 is a view showing an example of a startup sequence according to the second embodiment;

FIG. 12 is a view showing an example of a flow of processing performed by a system control unit according to a third embodiment;

FIG. 13 is a view showing an example of a startup sequence according to the third embodiment;

FIG. 14 is a view showing an example of the constitution of a multi-value correction calculation unit according to the third embodiment;

FIG. 15 is a view showing an example of a flow of processing performed by a system control unit according to a fourth embodiment; and

FIG. 16 is a view showing an example of a startup sequence according to the fourth embodiment.

### DESCRIPTION OF THE EMBODIMENTS

According tithe present invention, a video exhibiting reduced brightness variation (brightness variation among a plurality of display elements) can be displayed in a short time. For example, an activation time (a time required to display the video) generated by the transfer of correction data used in correction processing for reducing the brightness variation (brightness variation correction) can be shorted. In a case where the brightness variation is dependent on a gradation value, a volume of the correction data increases, and therefore a highly favorable effect can be expected from the present invention.

There are no particular limitations on a driving (modulating) system used in the image display apparatus, but since the brightness variation is dependent on the gradation value, a driving system that controls a voltage waveform as preferable. For example, an active matrix type driving system or a simple matrix type driving system is preferable. More specifically, a voltage driving type pulse width modulation system (PWM), a pulse amplitude modulation system (PHM), a system combining PWM and PHM, or a current driving system (since the voltage waveform applied to the display element ultimately varies) is preferable. A PHM system, a system combining PWM and PHM, or the like, in which an amplitude (a field intensity) of a modulation signal is modulated in accordance with the gradation value, is particularly preferable due to the pronounced gradation dependency of the brightness variation.

There are no particular limitations on the type of display element used in the present invention. For example, electron-emitting devices, EL elements, liquid crystal elements, plasma elements, and so on may be used. Electron-emitting devices, EL elements, and so on, in which she brightness is controlled by the field intensity, may be used particularly favorably from the viewpoint of the gradation dependency of the brightness variation. Surface conduction type electron-emitting devices, Spindt type electron-emitting devices, MIM type electron-emitting devices, carbon nanotube type electron-emitting devices, and BSD type electron-emitting devices, for example, may be used as the electron-emitting devices.

In a large-screen image display apparatus using a plurality of display elements, emission current variation among the plurality of display elements tends to be large, and therefore brightness unevenness (brightness variation) is more likely to occur. Therefore, the present invention is applied favorably to a large-screen (a screen having a diagonal size of at least 20 inches) image display apparatus using a plurality of display elements.

In a high-definition image display apparatus, the volume of correction data increases, leading to an increase in transfer volume (and the time required for transfer). Therefore, the present invention is applied favorably to a high-definition (a high-definition, high-resolution such as 2K1K or 4K2K) image display apparatus.

Further, the correction data must be held in a non-volatile memory such as a flash memory even when a power supply of the image display apparatus is disconnected. Moreover, the correction data must be transferred from the low-speed non-volatile memory to a high-speed volatile memory such as a DRAM for brightness variation correction during activation and display mode switching. Therefore, the present invention is applied favorably to a system in which the correction data must be transferred between two memories constituted by a correction data holding memory (a storage memory) and a processing memory (a work memory), a system having a low transfer speed, and so on.

Further, a constitution in which a predetermined video signal is input from a video signal supply apparatus during activation of the image display apparatus and display mode switching is preferable since the time required to display the video can be shortened greatly by the present invention (as will be described in detail below). For example, in a preferable constitution, the video signal supply apparatus performs control to display a still image such as a manufacturer's logo or an OSD (On Screen Display) image from a point at which an activation operation or a display mode switching operation is performed to a point at which normal display begins.

### First Embodiment

An image display apparatus and a control method for the image display apparatus according to a first embodiment of the present invention will be described below. In this embodiment, an example in which electron-emitting devices are used as the display elements and the electron-emitting devices are subjected to simple matrix driving using a modulation system including PWM will be described. Further, in this embodiment, the correction data are prepared for each of a plurality of display elements, and the correction data for a single display element are constituted by N (where N is an integer of 2 or more) correction values corresponding to N gradation values. As described above, however, the present invention is not limited to this constitution.

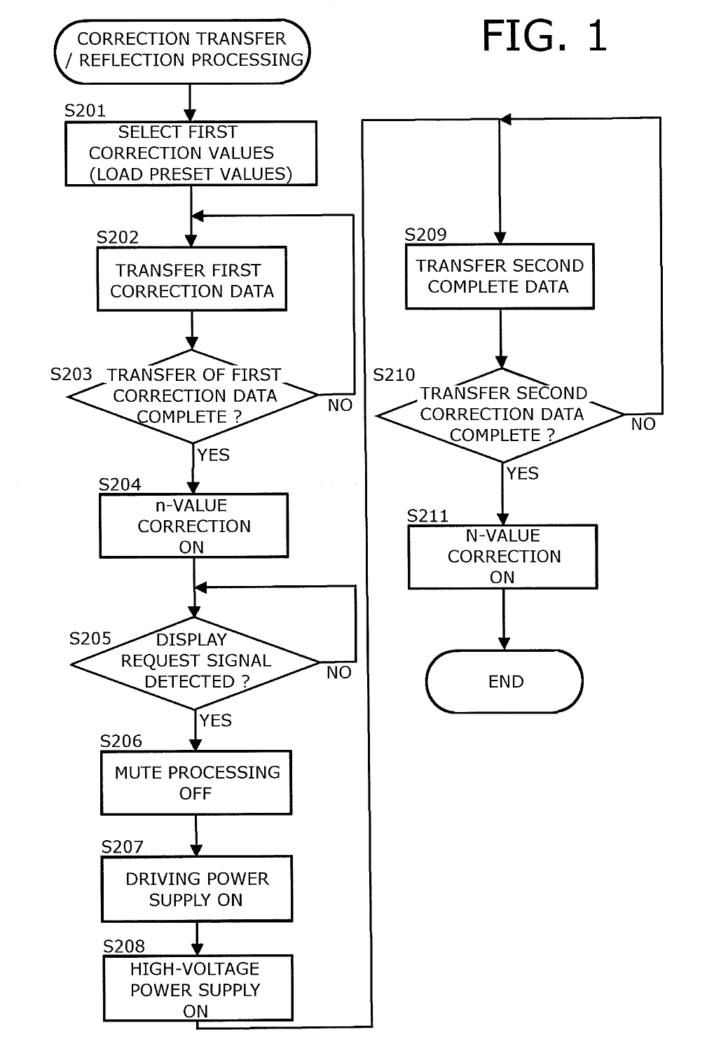

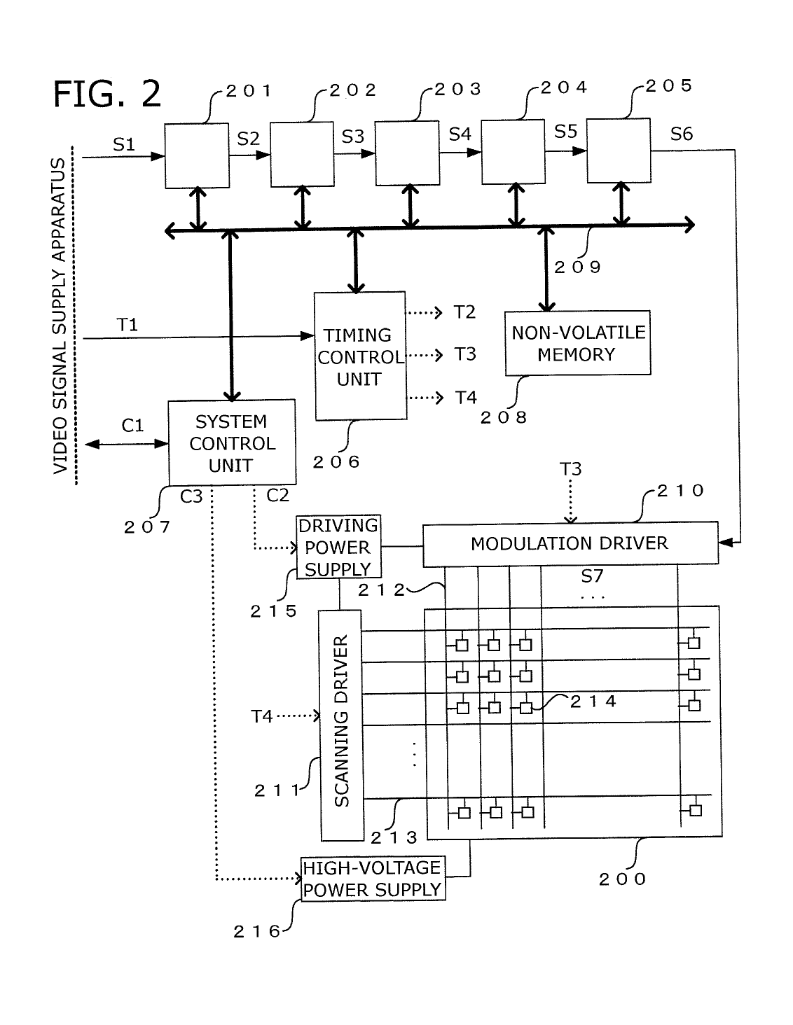

FIGS. 1 and 2 are representative diagrams illustrating the image display apparatus and the control method thereof according to this embodiment. FIG. 1 is a view showing an example of a flow of processing performed during activation of the image display apparatus according to this embodiment, and FIG. 2 is a block diagram showing an example of the overall constitution of the image display apparatus according to this embodiment.

(Overall Description of Image Control Apparatus)

First, the functional constitution of the image display apparatus according to this embodiment will be described using FIG. 2.

A reference numeral 200 denotes a display panel. The display panel includes a plurality of display elements disposed in a matrix form. In this embodiment, a display panel in which a rear plate and a face plate oppose each other via a support member known as a spacer is used as the display panel. The rear plate has a multi-electron source in which the plurality of display elements (cold cathode elements, for example) are arranged in a matrix form (for example, 5759 (=1920×RGB) horizontal direction×1080 vertical direction electron-emitting devices 214). The face plate includes a glass substrate, a plurality of phosphors provided on the glass substrate so as to oppose the plurality of electron-emitting devices, respectively, and a metal back covering the plurality of phosphors.

The plurality of electron-emitting devices 214 are wired into a simple matrix using a plurality of modulation wirings 212 and a plurality of scanning wirings 213. By applying signals from a modulation driver 210 and a scanning driver 211 to the modulation wirings 212 and the scanning wirings 213, electrons are emitted from desired electron-emitting devices. By setting a potential of the metal back at a high potential using a high-voltage power supply 216, the emitted electrons accelerate so as to pass through the metal back and collide with the phosphors. As a result, the phosphors emit light, whereby an image (a video) is displayed. A constitution and a manufacturing method for a display panel having a plurality of electron-emitting devices is disclosed in detail in Japanese Patent Application Laid-open No. 2000-250463, for example.

Next, processing performed in the image display apparatus according to this embodiment, and more particularly processing performed between input of a video signal and display of a video, will be described. The image display apparatus is connected to a video signal supply apparatus and is constituted mainly by two parts, namely a part that performs processing using video signals such as a video signal S1 and a synchronization signal T1 and a part that performs processing using a command signal such as a communication signal C1.

First, processing up to a point at which a drive signal S6 input into the modulation driver 210 is generated from the video signal S1 input from the video signal supply apparatus will be described.

The video signal S1 is input into an RGB input unit 201. The RGB input unit 201 includes a conversion circuit for converting the video signal S1 such that a horizontal resolution, a number of scanning lines, a frame rate, a clock frequency, and so on conform to those of the display panel 200, an adjustment circuit for adjusting properties such as a color temperature and a white balance, and so on. The RGB input unit 201 implements predetermined processing on the video signal S1 no the conversion circuit and adjustment circuit, and outputs the result as a signal S2.

The signal S2 is input into an inverse γ correction unit 202. The inverse γ correction unit 202 converts the signal S2 such that a relationship between a brightness value (an output value) on the display panel and a value (data) of the video signal is linear, and outputs the result as a signal S1. The data of the converted signal S3 are proportional to the brightness value, and therefore the data of the signal S3 will be referred to hereafter as “brightness data”. Assuming that the video signal S1 is to be displayed by a CRT display apparatus, the video signal S1 is typically subjected to non-linear conversion (gamma conversion) by a power of 0.45 or the like, in accordance with an input-light emission characteristic of the CRT display, and then transmitted or recorded. The inverse γ correction unit 202 implements inverse gamma conversion by a power of 2.2 or the like on the video signal so that the video signal can be displayed on a display apparatus having a linear input-light emission characteristic, such as a FED or a PDP.

The signal S3 is input into a brightness variation correction unit 203 serving as a feature of this embodiment. The brightness variation correction unit 203 implements correction processing for reducing brightness variation (variation in an electron emission characteristic among the plurality of electron-emitting devices 214) on the signal S3 and outputs the result as a signal S4. The brightness variation correction unit 203 will be described in detail below. Note that data of the signal S4 are data in which the brightness variation has been corrected and will therefore be referred to as corrected brightness data hereafter.

The signal S4 is input into a phosphor correction unit 204. The phosphor correction unit 204 implements linearity correction on the signal S4 the corrected brightness data) taking into account a non-linearity of the modulation driver 210, a brightness saturation characteristic of the phosphors, and so on such that selected display elements emit light at a brightness that is proportional to the corrected brightness data, and outputs the result as a signal S5. In this embodiment, non-self light emitting electron-emitting devices are envisaged as the display elements, and therefore linearity correction is implemented on the signal S4 to ensure that the phosphors opposing the selected electron-emitting devices emit light at a brightness that is proportional to the corrected brightness data. Note that when the brightness saturation characteristic of the phosphors is different for each color of R, G, and B, different conversion (correction) may be implemented on the corrected brightness data for each color.

The signal S5 is input into a drive conversion unit 205. The drive conversion unit 205 rearranges the data (the data of the signal S5) input in RUB parallel to correspond to the arrangement of the RUB phosphors of the display panel 200. Further, the drive conversion unit 205 converts. The data of the signal S5 into data conforming to an input format (Mini LVDS, RSDS, and so on, for example) of the modulation driver 210 and outputs the result as the drive signal S6. Note that the data of the signals S5 have values that are proportional to the brightness, whereas the data of the drive signal S6 are non-linear in relation to the brightness.

Note that operation timings of the respective signal processing units (the functions denoted by the reference numerals 201 to 205) are controlled by a synchronization signal T2 generated by a timing control unit 206 on the basis of the synchronization signal T1 received from the video signal supply apparatus.

Further, operating modes of the respective signal processing units (the functions denoted by the reference numerals 201 to 205) are controlled by a system control unit 207 by setting respective parameters via a system bus 209. The system control unit 207 may be constituted by logic alone or by a CPU, a microcomputer, and a media processor capable of parallel computing. A program for performing the control may be built into a ROM or transferred from the outside via an input/output interface. Various parameters relating to a small data volume or a large data volume, which is the problem to be solved by this embodiment, may be used, but in all cases, the parameters must be stored even when a power supply is interrupted. Therefore, the parameters are stored in a large-volume non-volatile memory 208 (a storage memory; first storage unit) represented by a flash memory or the like so that the parameters can be read by the system control unit 207 as required and used to perform setting. The non-volatile memory 208 is not limited to a NAND type or a NOR type flash memory, and may be a ROM or a hard disk. Alternatively, a constitution in which a volatile memory such as an SRAM is battery-driven and thereby used as a non-volatile memory may be employed.

Further, the system control unit 207 receives various requests, such as an activation request and an operating mode switch request, from the video signal supply apparatus side via the communication signal C1, and in the absence of an error controls the image display apparatus in accordance with the received request. When an error occurs, the system control unit 207 notifies the video signal supply apparatus side thereof and performs error processing (a forcible shutdown or the like) on the image display apparatus as a failsafe.

Next, processing performed from a point at which the drive conversion unit 205 outputs the drive signal S6 to a point at which the display panel 200 is driven to perform video display will be described.

The modulation driver 210 receives the drive signal S6 from the drive conversion unit 205. Then, on the basis of a timing control signal T3 from the timing control unit 206, the modulation driver 210 applies a modulation signal to the modulation wirings 212 in each selection, period during which a scanning wiring is selected by the scanning driver 211.

The scanning driver 211 selects lines (scanning wirings) sequentially in accordance with a timing control signal T4 from the timing control unit 206, and applies a predetermined selection signal to the selected scanning wiring during a corresponding selection period.

A driving power supply 215 supplies power for driving the modulation driver 210 and the scanning driver 211.

Hence, the modulation driver 210 drives the modulation wiring 212 using a modulation signal corresponding to the drive signal S6, and at the same time, the scanning driver 211 outputs a selection potential (a scanning pulse) to the scanning wiring 213. As a result, the electron-emitting device 214 connected to the selected scanning wiring 213 and the modulation wiring 212 to which the modulation signal is applied performs electron emission corresponding to the modulation signal applied to the modulation wiring 212.

The high-voltage power supply 216 generates an acceleration voltage (8 to 10 kV), and the potential of the metal back is set at a high potential by the acceleration voltage. As a result, electrons emitted from the electron-emitting device accelerate so as to collide with the phosphor. When the electrons collide with the phosphor, the phosphor emits light.

By selecting all of the scanning wirings sequentially and performing the processing described above, an image corresponding to a single screen is formed (displayed) on the display panel 200.

Note that the driving power supply 215 and the high-voltage power supply 210 are preferably constituted so that adaptive control can be executed thereon using control signals C2, C3 from the system control unit 207. It is particularly preferable to control a driving sequence of the respective power supplies according to an appropriate startup/shutdown sequence and to control a boosting method and a step-down method for the high-voltage power supply during activation, when the power supply is switched OFF, and when an error occurs.

(Description of Need for Multi-Value Correction)

Next, reasons why multi-value correction is required in the brightness variation correction unit 203 will be described. Multi-value correction is correction processing using correction values corresponding to at least two gradation values, which is executed in relation to brightness variation that differs for each gradation value.

First, an example of the modulation signal output by the modulation driver 210 will be described. An emission current of the electron-emitting device can be control led in accordance with an applied driving voltage, and therefore the brightness can be controlled in accordance with the pulse amplitude of the modulation signal. The brightness can also be controlled in accordance with the pulse width of the modulation signal.

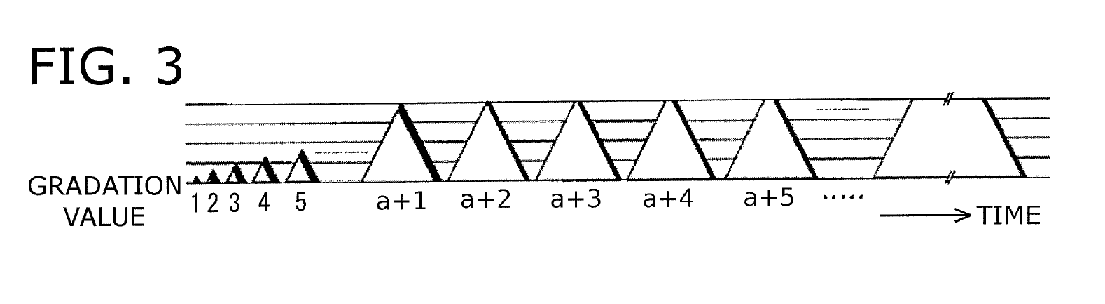

In this embodiment, a case in which the display panel is driven using a system of modulating both the pulse width and the pulse amplitude, such as that shown in FIG. 3, will be described. In FIG. 3, waveforms (drive waveforms, corresponding to S7 in FIG. 2) of modulation signals corresponding to respective gradation values are arranged horizontally with the ordinate showing the potential and the abscissa showing time. Here, the gradation values are numbered in ascending order of a signal level that can be taken by the modulation signal, and correspond to the drive signal S6 output by the drive conversion unit 205.

In this type of modulation system, a gradation performance at a subject gradation value improves steadily as a difference in pulse width and pulse amplitude between the drive waveform of the subject gradation value and drive waveforms corresponding to front and rear gradation values decreases. Further, in this modulation system, the aforementioned difference can be reduced in a low brightness region (a low gradation region; a region having small gradation values) in comparison with a PWM modulation system in which the pulse amplitude is fixed. As a result, the number of gradation values in the low gradation region can be increased (the gradation performance can be improved in the low gradation region). However, in this modulation system, the pulse amplitude decreases on the low gradation side in comparison with normal PWM, leading to an increase in brightness variation on the low gradation side. This gradation dependency of the brightness variation will be described in detail, below.

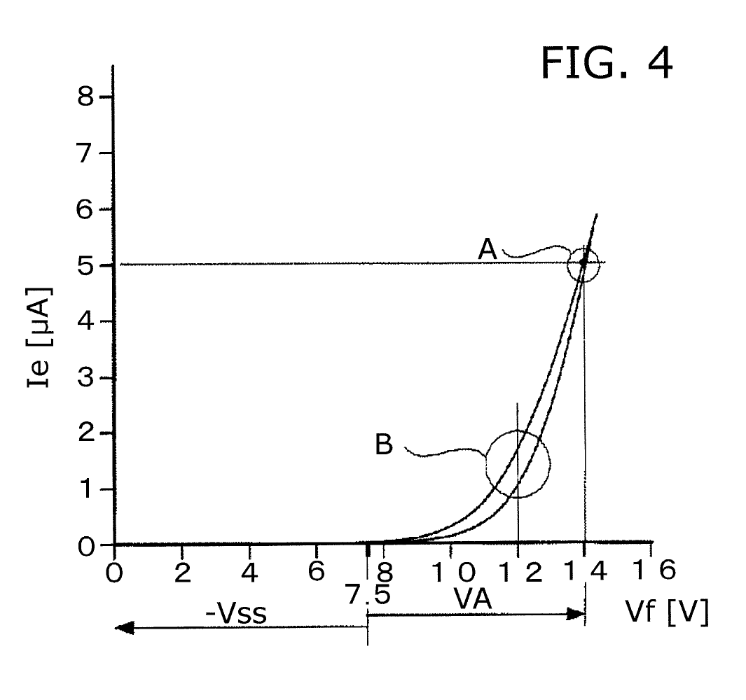

Through committed research, the present inventors learned that a major cause of brightness variation is emission current variation among the plurality of electron-emitting devices. FIG. 4 is a graph showing in pattern form a characteristic of the electron-emitting device, on which the abscissa shows the driving voltage and the ordinate shows the emission current. The driving voltage is a voltage (Vf) applied to the electron-emitting devices 214, and corresponds to a difference between a potential (−Vss) of the selection signal and a potential (VA) of the modulation signal (Vf=VA+Vss). Further, in FIG. 4, the potential (−Vss) of the selection signal is set at −7.5 V and a maximum value of the potential (VA) of the modulation signal is set at 7 V. It can be seen from FIG. 4 that electrons are emitted from the electron-emitting devices to which the selection signal is applied in accordance with the potential (VA) of the modulation signal. It can also be seen that no electrons are emitted from the electron-emitting devices to which neither the selection signal nor the modulation signal is applied.

On the actual display panel 200, considerable characteristic variation occurs among the plurality of electron-emitting devices. FIG. 4 shows the characteristics of two electron-emitting devices in pattern form as an example. In FIG. 4, a part indicated by A is a part in which the potential of the modulation signal is high, and therefore emission current values of the two elements are comparatively closely aligned. A part indicated by B is a part in which the potential of the modulation signal is lower than that of the part A, and therefore the emission current values of the two elements deviate (vary) greatly from each other. Further, at driving voltage between the part A and the part B, the emission current values of the two elements deviate to a greater extent than in the part A but not as greatly as in the part B. This variation in the emission current value causes brightness variation among the plurality of display elements. Furthermore, the gradation dependency of the brightness variation is due to the fact that the degree of variation in the emission current value differs according to the value of the driving voltage.

Further, when a number of emission points (a number of positions in which electrons are emitted) varies among the plurality of electron-emitting devices, the respective electron-emitting devices have a characteristic obtained by multiplying the ordinate of FIG. 4 by a constant (a ratio of the number of emission points), and therefore the brightness variation exhibits substantially no gradation dependency. When an electric field multiplication coefficient of the electron-emitting device (a shape and a distance between an emitter and a gate) varies, on the other hand, the respective electron-emitting devices have a characteristic obtained by multiplying the abscissa of FIG. 4 by a constant (a ratio of a driving field), and therefore the brightness variation exhibits pronounced gradation dependency. Hence, when the number of emission points and the electric field multiplication coefficient vary independently, brightness variation relationships among the plurality of gradation values vary according to the content of the variation in the number of emission points and the variation in the electric field multiplication coefficient. Therefore, to obtain an accurate correction value, the brightness variation must be measured with regard to at least two gradation values. Furthermore, since the brightness variation may be gradation-dependent, the correction values of the respective display elements must be set for each gradation value. When correction processing is implemented on the low gradation region, correction values must be set for each gradation value in the low gradation region.

Hence, multi-value correction is required for the reasons described above.

However, when correction values are prepared for each of the display elements in relation to all of the gradation values, a massive increase occurs in the data volume, and therefore this method cannot realistically be put into practice using hardware. Hence, in this embodiment, several representative gradation values are selected from the gradation values, and the correction values corresponding to the remaining gradation values are generated using a correction value curve obtained by interpolating the correction values corresponding to the representative gradation values.

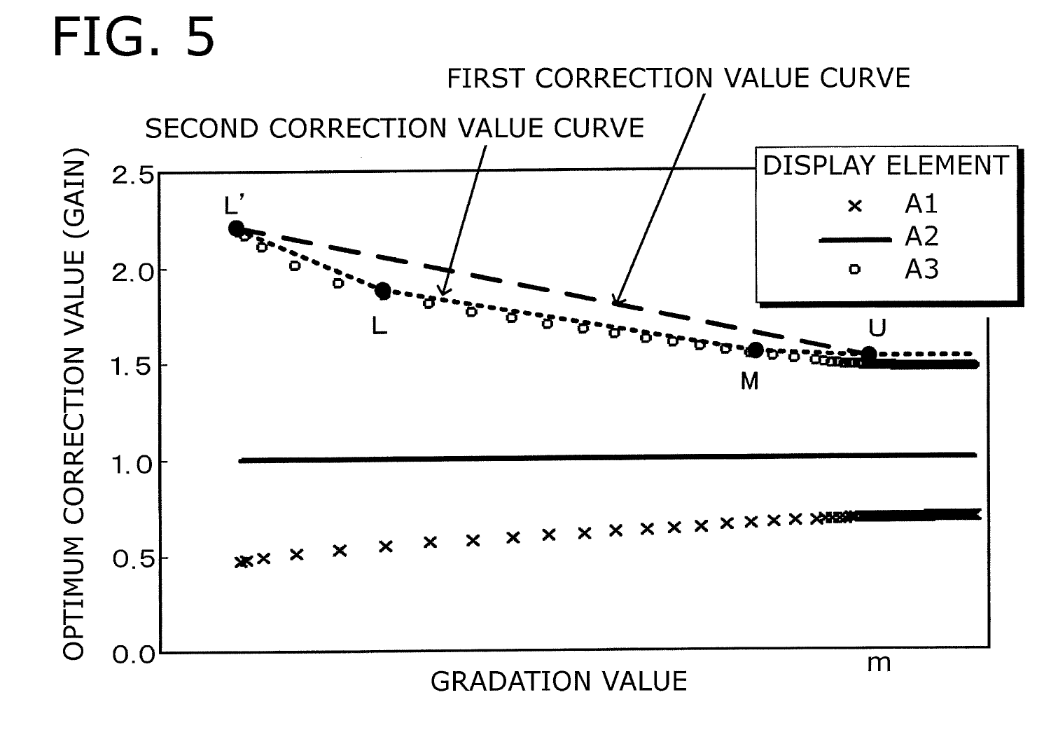

FIG. 5 shows the gradation dependency of correction values in a case where gradation values of a display element A1 and a display element A3 are corrected so as to align with the brightness of a display element A2.

FIG. 5 shows a case in which plot points of the display element A3 are set as ideal values and four correction values (a U (Upper) point, an M (Middle) point, an L (Lower) point, and an L′ (Lower′) point) corresponding to four representative gradation values from a gradation value m downward are interpolated. However, in the example of FIG. 5, the correction values are interpolated linearly, and therefore the correction value curve includes an error (an interpolation error; in other words, a deviation occurs between the ideal value and the value obtained from the correction value curve). To reduce the error in the correction value curve, the number of representative gradation values must be increased to a certain extent.

(Specific Example of Multi-Value Correction)

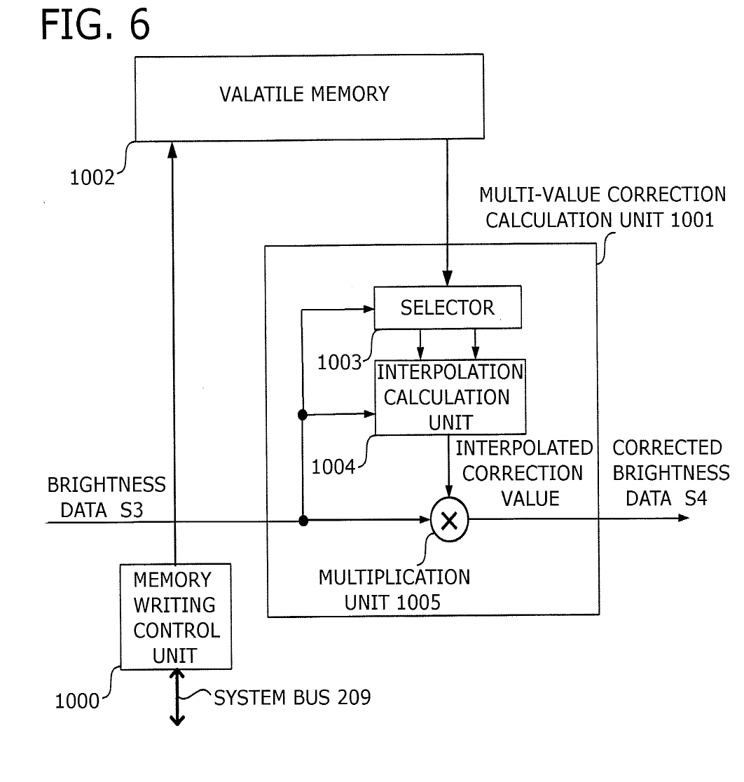

A hardware configuration for realizing multi-value correction using a correction value curve such as that described above will now be described with reference to FIG. 6. FIG. 6 is a block diagram showing in detail the brightness variation correction unit 203. FIG. 6 is broadly divided into two processing systems, namely a correction data writing/transfer processing system and a correction data reading/calculation processing system. Each processing system will be described in detail below.

(Correction Data Writing/Transfer Processing System)

This processing system is provided as a prior stage to brightness variation correction in which, at the time of activation, correction data are transferred from the low-speed non-volatile memory to the high-speed volatile memory. More specifically, at the time of activation, the system control unit 207 opens the system bus 209 to a memory writing control unit 1000. When preparation is complete, the system control unit 207 performs transfer by reading the correction data stored in the non-volatile memory 208 continuously to the memory writing control unit 1000. This type of transfer is typically known as DMA transfer.

The memory writing control unit 1000 stores the correction data transferred on the system bus 209 in an internal buffer and writes the correction data to a volatile memory 1002 capable of a high-speed operation. Note that when the memory writing control unit 1000 writes the correction data to the volatile memory 1002, the format of the correction data is converted if necessary. Hence, in this embodiment, the system control unit 207 and the memory writing control unit 1000 together constitute transfer unit according to the present invention.

The volatile memory 1002 is a memory (second storage unit) used as a work memory. The volatile memory 1002 is typically constituted by a DRAM, an SRAM, or similar that is inexpensive and capable of a high-speed operation, such as an SDRAM or a DDR2-SDRAM.

In the example of FIG. 5, correction values for four gradation values are transferred, and therefore, assuming that the number of display elements is 1920×1080×3 (=RGB) and a single correction value is 8 bits, the transfer volume was calculated as follows.

Transfer volume=1.920×1080×8 bits×3(=RGB)×4=199065600 bits (=12441600 words)

A transfer time required to transfer the above transfer volume was calculated envisaging a case in which the system control unit 207 is a typical 16-bit microcomputer or the like. More specifically, assuming that a bus clock of the system bus 209 is 25 MHz and that during a single bus cycle of the DMA transfer, the data for one word are transferred in a period corresponding to seven cycles, the transfer time was calculated as follows.

Transfer time=12441600 words×40 ns×7=2.18 sec

This transfer time lasting several seconds is the problem to be solved by this embodiment.

(Correction Data Reading/Calculation Processing System)

This processing system is provided to implement brightness variation correction on an input video signal while referencing the volatile memory 1002. More specifically, a multi-value correction calculation unit 1001 (correction unit) corrects the gradation values of the signal S3 using a correction value curve obtained by interpolated correction values read from the volatile memory 1002, and outputs the result as the signal S4.

The system control unit 207 instructs the multi-value correction calculation unit 1001 to begin multi-value correction. The multi-value correction calculation unit 1001 reads the four correction values corresponding to the four gradation values from the volatile memory 1002 in synchronization with the synchronization signal T2 from the timing control unit 206. A selector 1003 then selects two correction values, i.e. the minimum number of correction values required for multi-value correction, from the four read correction values, and outputs the two selected correction values to an interpolation calculation unit 1004.

A selection method employed by the selector 1003 in the example shown in FIG. 5 will now be described.

When a gradation value of the signal S3 (the brightness data) is a gradation value between the gradation values of the U point and the M point, the selector 1003 selects the U point, and the M point. When the gradation value is between the gradation values of the M point and the L point, the selector 1003 selects the M point and the L point. When the gradation value is between the gradation values of the L point and the L′ point, the selector 1003 selects the L point and the L′ point. The selector 1003 selects the U point when the gradation value is larger than the U point and selects the L′ point when the gradation value is smaller than the L′ point.

A calculation method employed by the interpolation calculation unit 1004 will now be described specifically.

A case in which the gradation value of the brightness data is set as din and din is between the gradation values of the M point and the L point will be described. Assuming that coordinates of the M point are (m_th, m_coef) and coordinates of the L point are (l_th, l_coef), a correction value dout (an interpolated correction value) corresponding to the gradation value din can be calculated using a following equation.

dout=(1/m_{—}th−l_{—}th))××((m_coef−l_coef)×din+m_{—}th×l_coef−l_{—}th×m_coef)=(1/m_{—}th−l_{—}th))×(l_coef×(m_{—}th−din)+m_coef×(din−l_{—}th)

(where l_th<din<m_th)

By multiplying the correction value dout by the brightness data in a multiplication unit 1005, corrected brightness data (the signal S4) are obtained. Hence, when the correction value is 1, the brightness data are output as is, when the correction value is smaller than 1, correction is performed to reduce the gradation value (reduce the brightness), and when the correction value is larger than 1, correction is performed to increase the gradation value (increase the brightness). Note that the correction value may be calculated using a similar method when the value of din is a gradation value between the gradation values of the U point and the N point or the L point and the L′ point. Further, when the gradation value of the brightness data is not a gradation value between the gradation values corresponding to the correction values of U and L′, the U point or the L′ point may be set as the correction value.

(Processing Performed Upon Activation of a Conventional Image Display Apparatus)

As described above, the transfer time lasting several seconds is the problem to be solved by this embodiment.

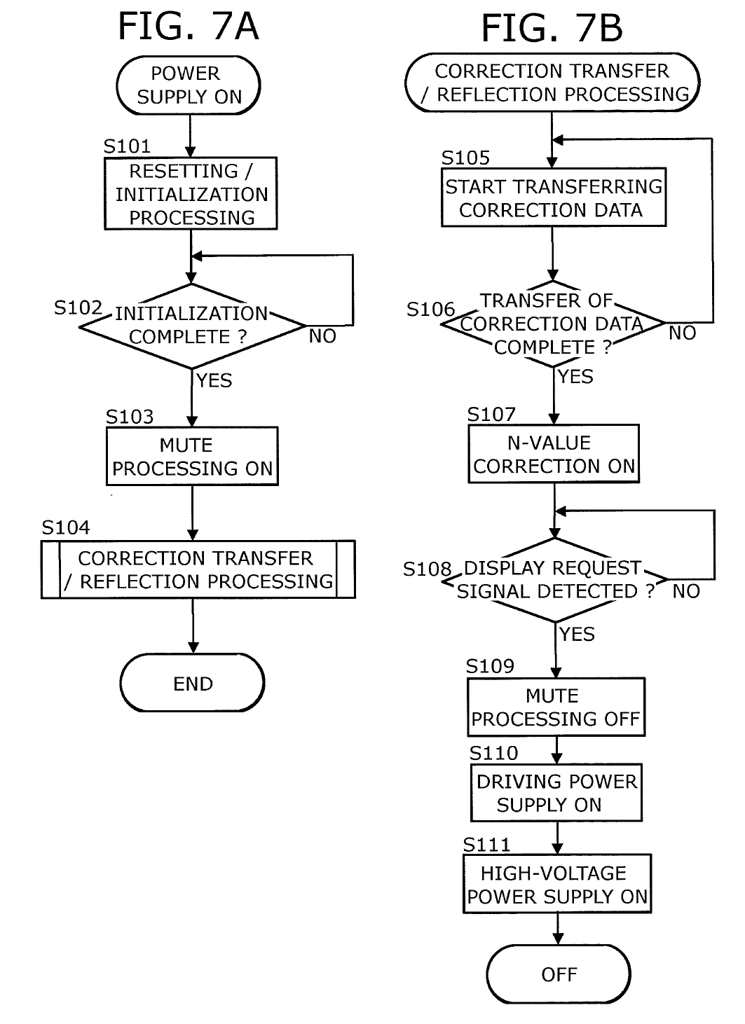

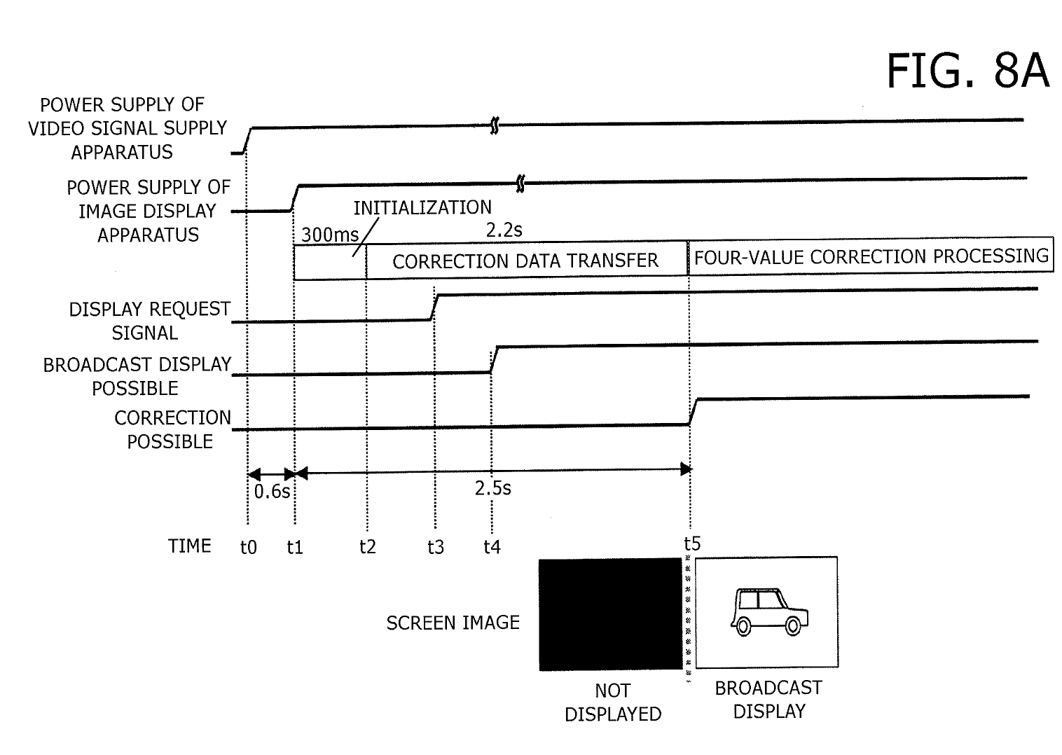

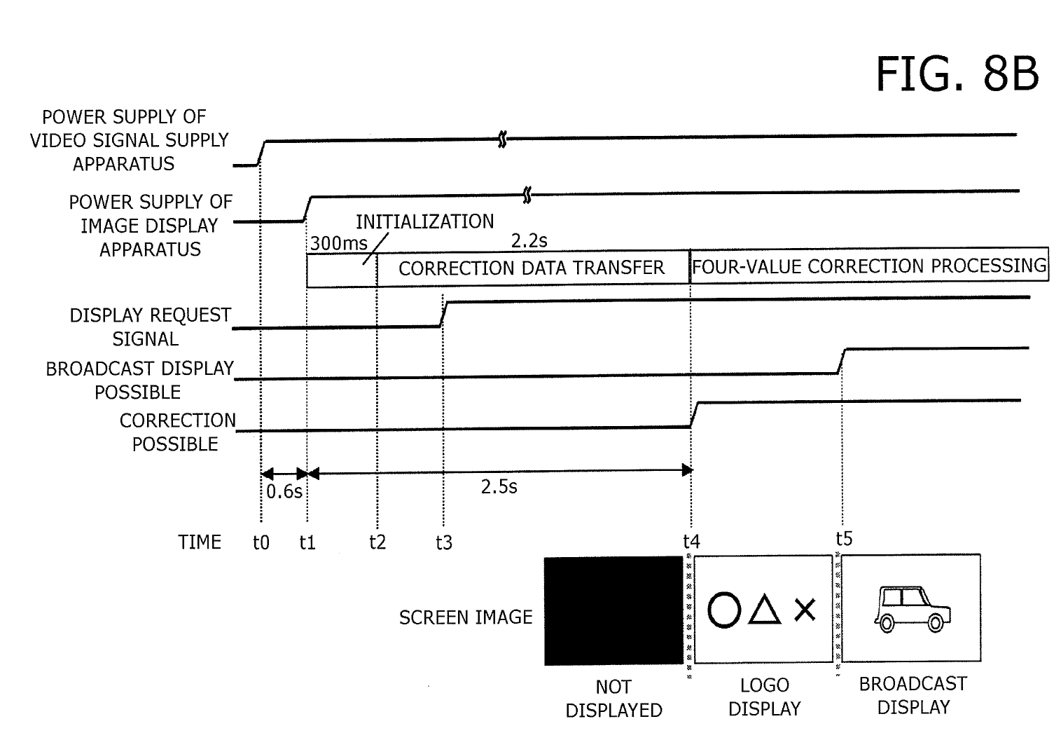

The importance of this problem will now be described using FIGS. 7A, 7B, 8A and 8B.

FIG. 8A is a view showing a conventional startup sequence (variation timings of various states). When the video signal supply apparatus is activated (when a power supply of the video signal supply apparatus is switched ON) at a time t0, the image display apparatus is activated (a power supply of the image display apparatus is switched ON) 0.6 seconds later at a time t1. When the image display apparatus is activated, the system control unit 207 is reset, whereby startup processing is begun in accordance with flowcharts shown in FIGS. 7A and 7B.

First, in S101 of FIG. 7A, resetting processing and initialization processing are performed. This processing includes boot-up processing for loading a program, hardware resetting processing, and all initialization processing relating to a PLL for generating an internal clock, the volatile memory 1002, and so on, and is constituted by a series of processes for setting the image display apparatus; in a normal operating condition.

When initialization completion is confirmed in S102, the drive signal S6 output from the drive conversion unit 205 is set forcibly at a black level in S103 (mute processing). This processing is performed for protection purposes to ensure that an unintended video is not output unintentionally, for example.

In S104 (at a time t2), correction transfer/reflection processing shown in FIG. 7B is performed. More specifically, in S105, correction data transfer is begun as described above. When N (in this embodiment, N=4) correction values have been transferred for each display element, in S106 (at a time t5), correction processing (N-value correction processing) using these correction values (all of the correction data) is enabled (made executable) in S107. As described above, correction processing using all of the correction data is processing for converting the gradation values of the input video signal using a correction value curve obtained by interpolating the N correction values.

Next, when a display request signal enabled at a time t3 is detected from the video signal supply apparatus in S108, the mute processing is switched OFF in S109. More specifically, the drive signal S6 is switched to the video signal subjected to brightness variation correction using all of the correction data. Note that the display request signal is a signal indicating stable input of the video signal from the video signal supply apparatus. More specifically, the display request signal is a signal that becomes active when the synchronization signal T1 and a video clock output, not shown in the drawings, are output with stability and a displayable video signal S1 is output from the video signal supply apparatus. Note that the broadcast video signal may become displayable (broadcast display thereof may become possible) at the same time as the display request signal is enabled or thereafter.

Then, by starting up (driving) the driving power supply 215 in S110 and starting up the high-voltage power supply 216 in S108, video display (display of a video used on the video signal subjected to brightness variation correction) on the display panel begins.

FIG. 8A shows an example of a case in which a preparation time (t4−t3) extending from the point at which the display request signal is enabled to the point at which broadcast display becomes possible is shorter than a startup time of the image display apparatus (a time extending from the point at which the display request signal is enabled to a point at which video display becomes possible; t5−t3). In this case, the broadcast video (a video based on a video signal generated from a broadcast signal) is displayed at the time t5.

FIG. 8B, on the other hand, shows an example of a case in which the preparation time (t5−t3) is longer than the startup time (t4−t3) of the image display apparatus. In this case, display is performed in two stages such that correction processing is implemented on a predetermined video signal at the time t4, whereby a video (a video of a manufacturer's logo or the like, an OSD image, and so on) based on the predetermined video signal subjected to the correction processing is displayed (logo display), and then, at the time t5, a broadcast video is displayed.

The reason why cases such as that shown in FIG. 8B occur is that due to broadcasting digitization, an increase has occurred in the amount of processing requiring a long time from a point at which the video signal supply apparatus receives a broadcast to a point at which a broadcast video is displayed. Examples of this processing include acquisition of a key required for descrambling, transfer of a large volume of data using a low-speed I2C bus or the like, an increase in activation time due to employment of an OS that is compatible with high functionality, and so on. Therefore, a problem arises in that a user must wait for a while after activating a television receiver (the video signal supply apparatus and the image display apparatus) until the broadcast video can be viewed. To solve this problem, a video such as a logo is displayed until broadcast display preparation is complete, as shown in FIG. 8B, as means for causing the user to acknowledge that an activation operation is being transmitted to a machine.

Hence, with a conventional method, it takes approximately three seconds (the activation time) for a video to be displayed from activation of the video supply apparatus (FIGS. 8A, 8B), and this time may increase further with improvements in the gradation of an image and definition of the display panel 200. For example, to improve the gradation performance of a dark portion (the low gradation region), correction values corresponding to a larger number of gradation values are required in the low gradation region, leading to an increase in the activation time. More specifically, when an increase in correction values from 4 to 6 occurs, the activation time increases 1.5 times to 4 seconds. Further, at super-high definitions compatible with digital cinema, such as 4K2K, the amount of data increases fourfold in comparison with HD, leading to a sharp increase in the activation time to 12 seconds.

In this embodiment, when a part of the correction data has been stored in the volatile memory 1002 following activation of the image display apparatus, the multi-value correction calculation unit 1001 begins interim correction processing using this part of the data, and video display is begun. Then, after the remainder of the correction data has been stored in the volatile memory 1002, the correction processing executed by the multi-value correction calculation unit 1001 switches to the correction processing using all of the correction data. As a result, a video exhibiting reduced brightness variation is displayed in a short time. This will be described in detail below.

(Processing Performed During Activation of the Image Display Apparatus According to this Embodiment)

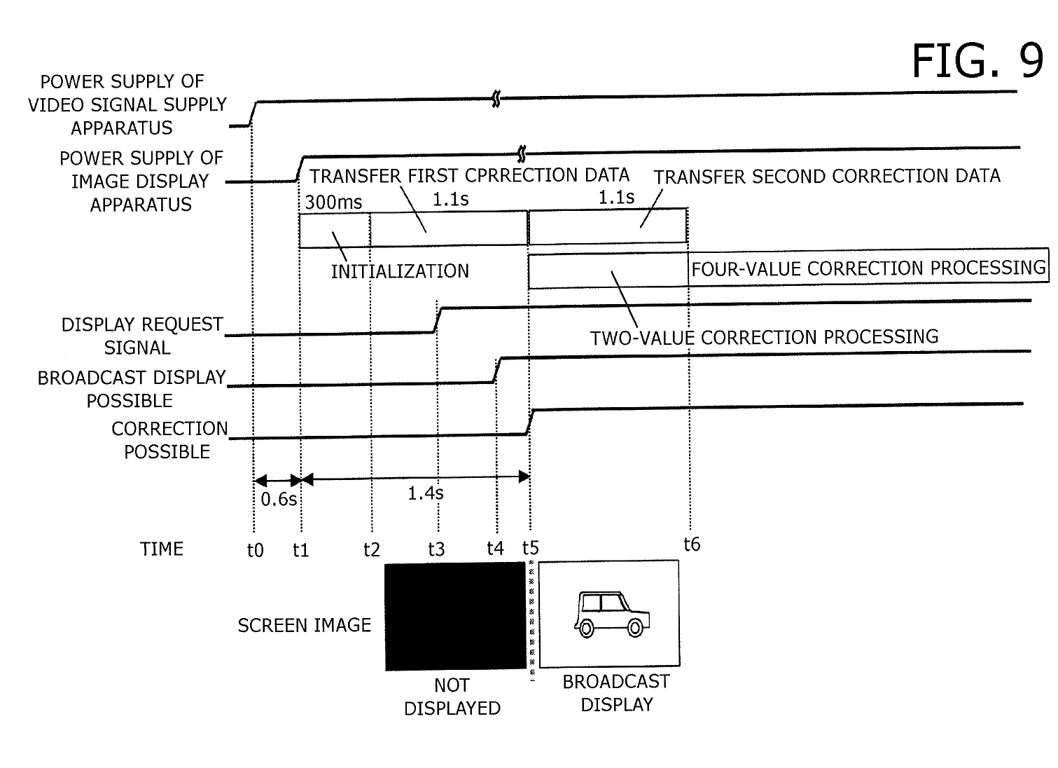

A specific example of the processing performed during activation of the image display apparatus according to the first embodiment will be described below using FIGS. 1 and 9.

FIG. 1 is a flowchart (a flowchart showing a processing flow of the system control unit 207 (control unit)) that corresponds to the correction transfer/reflection processing of S104 in FIG. 7A and shows a phased correction data transfer and correction reflection method serving as a feature of this embodiment. FIG. 9 is a timing chart showing an example of a startup sequence according to this embodiment.

At a time t2 in FIG. 9 following S103 in FIG. 7A, the system control unit 207 selects n (where n is an integer no smaller than 1 and smaller than N; in this embodiment two) first correction values to be transferred first from among the N correction values to be transferred (S201). The n first correction values (a part of the correction data) will be referred to hereafter as first correction data. In this embodiment, the two correction values (the U point and the L′ point) with which an average interpolation error can be reduced to a maximum extent in the entire region from the gradation value m downward in FIG. 5 are selected. These correction values are stored in the non-volatile memory 208 as preset values of the system control unit 207 and loaded in S201. Note that this selection method is merely an example, and a combination other than these two points may be selected.

Next, in S202, the selected first correction values stored in the non-volatile memory 208 are transferred to the volatile memory 1002.

When transfer of the first correction data is complete in S203 (at a time t5), the selector 1003 forcibly selects the first correction values (two values) and enables correction processing (interim correction processing; first correction processing) using the first correction values in S204. The interim correction processing is processing (n-value correction processing) for converting the gradation values of the input video signal using a correction value curve obtained by interpolating the n correction values (the first correction values).

Next, when the display request signal enabled at the time t3 is detected in S205, the drive signal S6 is switched to a video signal subjected to the interim correction processing (mute processing OFF) in S206. Then, by starting up the driving power supply in S207 and starting up the high-voltage power supply in S208, video display on the display panel 200 is begun (more specifically, since the time t5 is later than a time t4 at which broadcast display becomes possible, broadcast display is begun).

Next, in S209 (at the time t5), the remaining correction values (second correction values; in this embodiment, the M point and the L point) stored in the non-volatile memory 208 are transferred to the volatile memory 1002. The remaining correction values will be referred to hereafter as second correction data.

When transfer of the second correction data is complete in S210 (at a time t6), correction processing (second correction processing) using all of the correction data is enabled in S211. In other words, the correction processing is switched from the first correction processing to the second correction processing. Accordingly, the correction value curve is switched from a first correction value curve to a second correction value curve in FIG. 5. More specifically, the correction value selection method employed by the selector 1003 is switched to the method described above (a two-value selection method) in which two points are selected while referring to the brightness data.

Hence, in this embodiment, by performing control such that the interim correction processing and video display are begun at a point where a part of the correction data has been stored, a video exhibiting reduced brightness variation can be displayed in a short time. More specifically, by performing control to transfer half of the correction data so that interim correction processing and video display are started, the time required for video display can be reduced by half using a similar system configuration to that of the related art. Note that in the first correction processing, the interpolation error of the correction value curve is larger than in the second correction processing, but since the correction processing is switched to the second correction processing one or two seconds later, substantially no problems arise in terms of the visible image quality of the video.

Note that in this embodiment, a case in which multi-value correction is performed in the first correction processing is case in which two or more correction values are used as the first correction values, where N is an integer of three or more and n is an integer of 2 or more and less than N) was described, but a single correction value may be used as the first correction value. When the first correction value is a single correction value, correction processing using the same correction value may be implemented on any gradation value of the input video signal.

In this embodiment, the correction data are transferred and reflected in two parts, but not limited to this, and the correction data may be transferred and reflected in more than two parts. This is extremely effective for responding to a problem occurring when the volume of the correction data is large such that the time displayed a video subjected to the first correct ion processing increases, making image quality deterioration more easily recognisable.

In this embodiment, n correction values from the N correction values are used as the part of the data, but N or n correction values of display elements positioned in a partial region of a screen of the display panel may be used as the part of the data. For example, it may be predicted that the user is highly likely to focus on the center of the screen immediately after starting to watch, and therefore the correction values of the display elements in the central part of the screen may be used as the part of the data. Accordingly, the interim correction processing may be processing for correcting only a part of the input video signal to be displayed in a partial region.

In this embodiment, a startup sequence performed during activation of the image display apparatus was described as an example, but a similar problem occurs when a display mode is modified while the image display apparatus is operative such that different correction data must be transferred again. Hence, similar effects are obtained when the present invention is applied to a case in which the display mode (correction data) is switched.

In this embodiment, two correction values are selected forcibly in S204, but when the value of n is 3 or more, two values may be selected from the corresponding three correction values using the two-value selection method.

### Second Embodiment

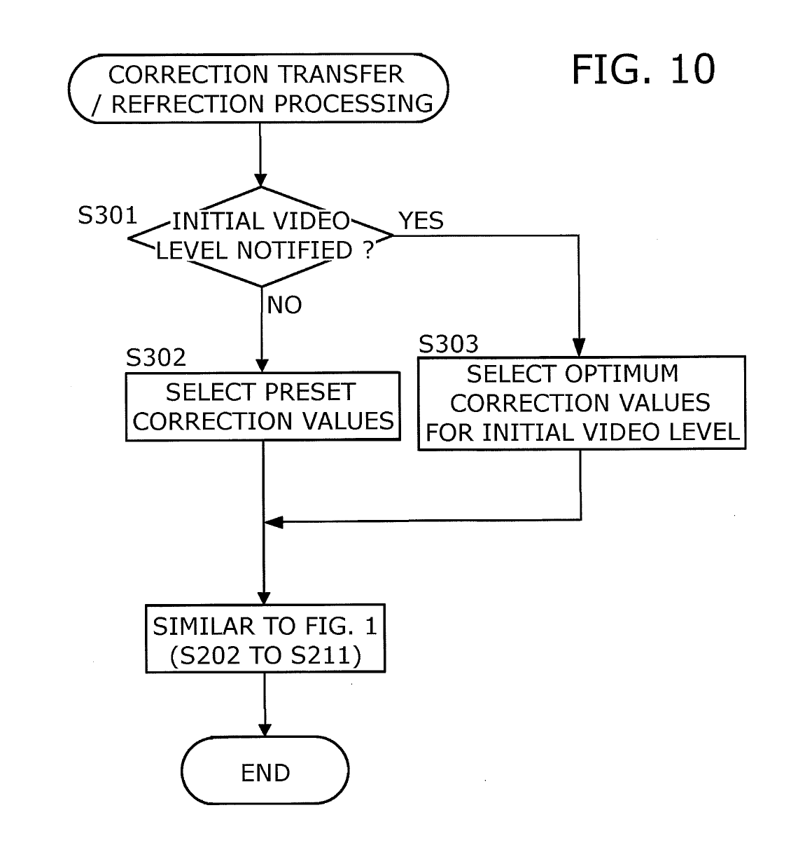

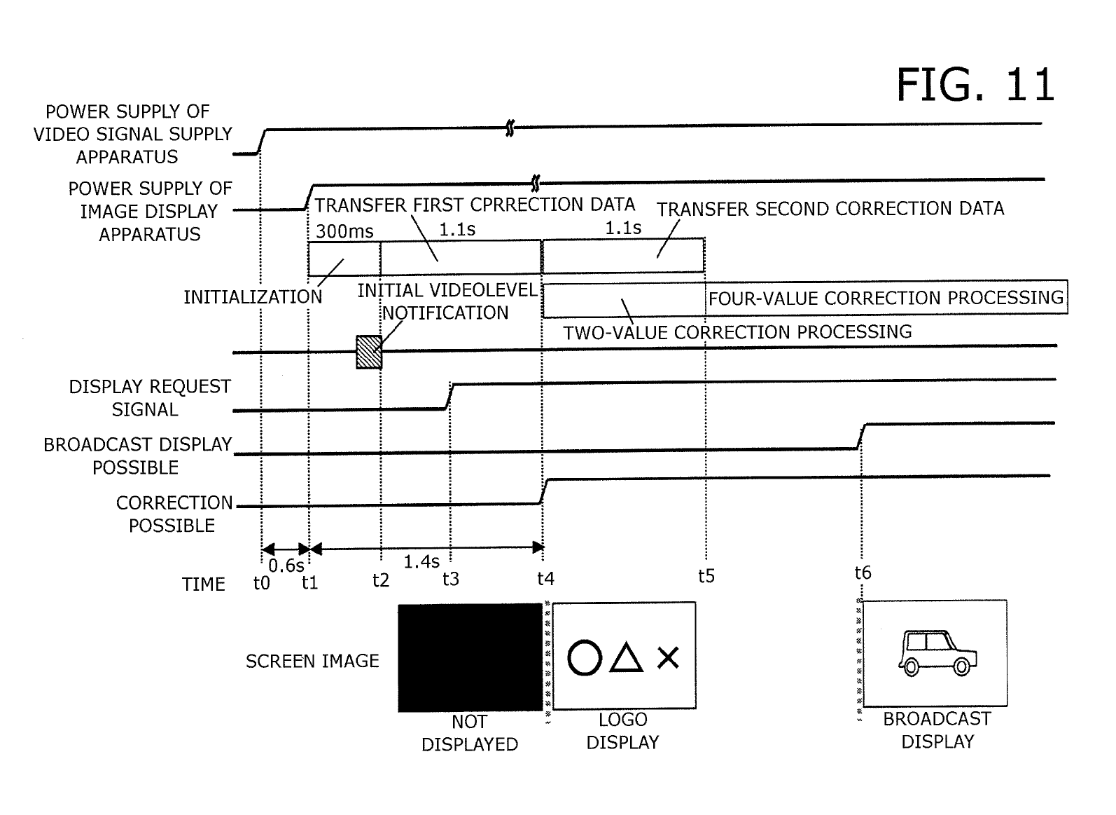

In a second embodiment of the present invention, a case in which the display video changes in stages, as shown in FIG. 8B, will be described using FIGS. 10 and 11. According to the constitution (control method) of this embodiment, the interpolation error of the correction value curve, used in the first correction processing can be reduced in comparison with the first embodiment. Parts that differ from the first embodiment will be described below.

FIG. 10 is a flowchart illustrating features of this embodiment, and FIG. 11 is a timing chart showing an example of a corresponding startup sequence. The second embodiment differs from the first embodiment in that a predetermined video signal is input into the image display apparatus from the video signal supply apparatus and notification is provided of a representative value (an initial video level) of the gradation values in the predetermined video signal.

The system control unit 207 receives notification of the initial video level up to a time t2 in FIG. 11 via the communication signal C1. When the notification is not received before the time t2 in S301, the preset first correction values are selected similarly to the first embodiment in S302. When the notification is received before the time t2, or the other hand, the routine advances to S303, in which optimum first correction values for the initial video level are selected. More specifically, at least n correction values including two correction values corresponding to the two gradation values on either side of the initial video level are selected from among the N correction values. The initial video level may be an average brightness level (APL; an average value of the gradation values), a maximum value and a minimum value of the gradation values of the video signal, or a value determined by analyzing a distribution of the gradation values. The initial video level should be the gradation value that best expresses the characteristics of the predetermined video signal.

Next, the first correction data are transferred by executing similar processing to the processing of S202 to S211 in FIG. 1, whereby logo display generated by enabling the first correction processing is begun at a time t4. At the same time, transfer of the second correction data is begun such that at a time t5, the display is switched to logo display generated by enabling the second correction processing. At a time t6, broadcast display becomes possible, whereby the display is switched to broadcast display generated by enabling the second correction processing.

Hence, in this embodiment, similarly to the first embodiment, a video exhibiting reduced brightness variation can be displayed in a short time. Furthermore, in this embodiment, optimum first correction values for the initial video level are selected, and therefore, in comparison with the first embodiment, a correction value curve having a smaller interpolation error in the vicinity of the initial video level can be obtained in the first correction processing.

Note that in this embodiment, the system control unit 207 is notified of the initial video level but may be notified of information indicating the n gradation values. In this case, the system control unit 207 should select n correction values corresponding to the notified n gradation values as the first correction values.

### Third Embodiment

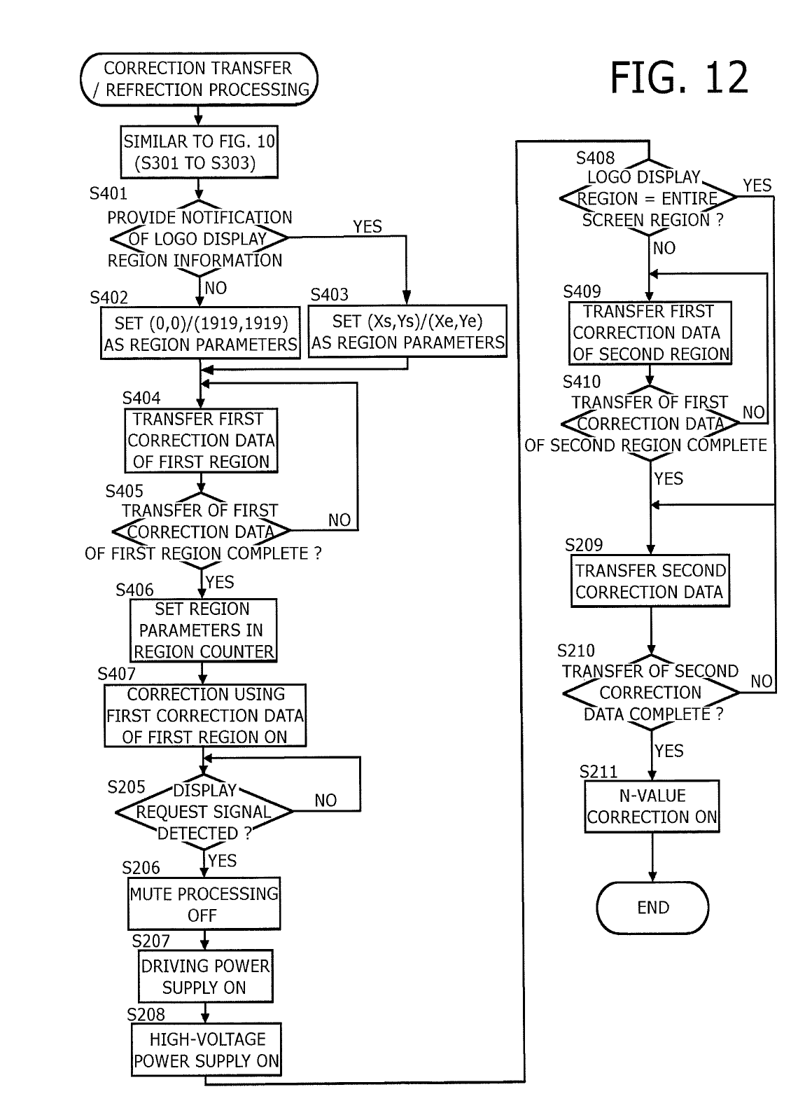

In a third embodiment of the present invention, a case in which the display video changes in stages, as shown in FIG. 8B, will be described using FIGS. 12, 13 and 14. According to the constitution (control method) of this embodiment, the time required to display a video can be reduced further in compare son with the first and second embodiments. Parts that differ from the second embodiment will be described below.

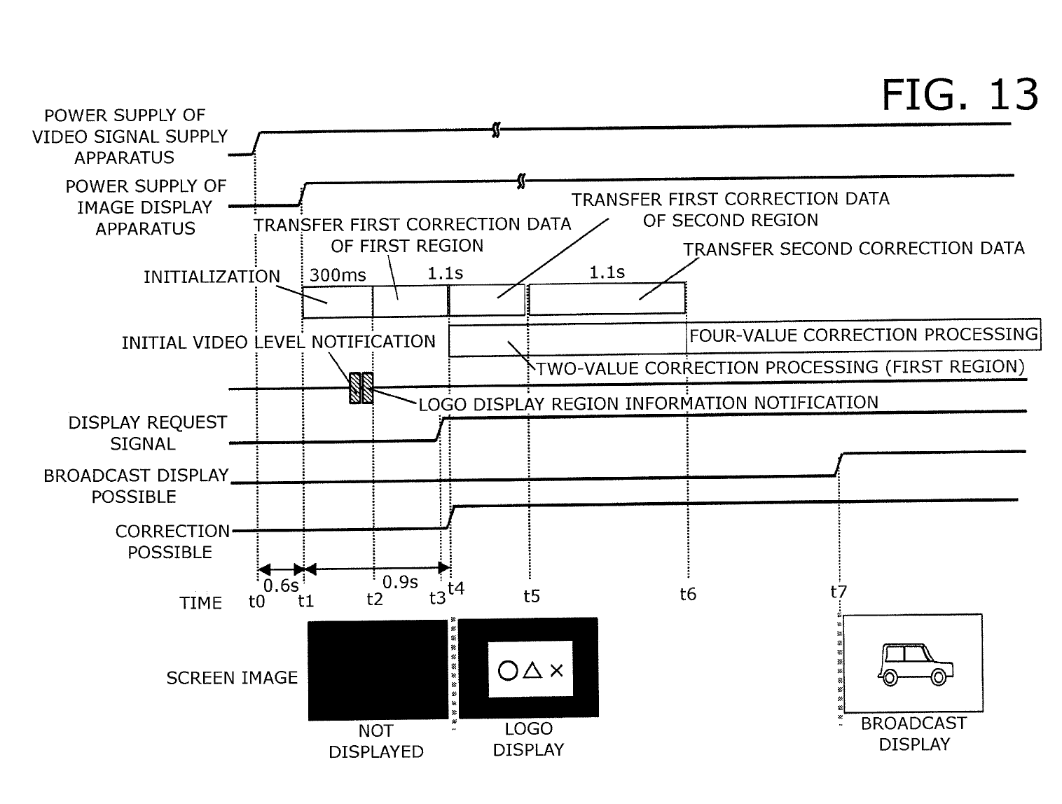

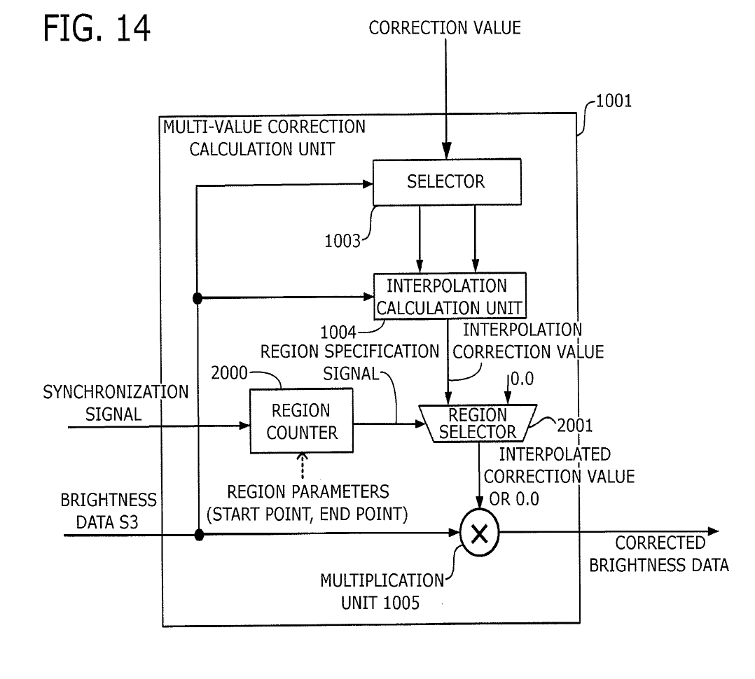

FIG. 12 is a flowchart illustrating features of this embodiment, in which identical numerals have been allocated to similar processing to the processing shown in FIGS. 1 and 10. FIG. 13 is a timing chart showing an example of a startup sequence according to the third embodiment. FIG. 14 is a view showing an internal constitution of the multi-value correction calculation unit 1001 for realizing the control that is a feature of the third embodiment. Identical reference symbols have been allocated to identical functions to those shown in FIG. 6.

In this embodiment, the predetermined video signal is assumed to be a video signal of a predetermined video (a logo image) displayed in a partial region of the screen. To facilitate understanding of this embodiment, a case in which the logo image corresponding to the predetermined video signal is displayed on half the surface area of the entire screen and the remaining part is left black will be described as an example. The third embodiment differs from the second embodiment in that the image display apparatus is notified of information (logo display region information) indicating a display region (a logo display region; a first region) of the video based on the predetermined video signal. Note that the logo display region does not have to be half the surface area of the screen, and a position and a size thereof may take any value.

The system control unit 207 receives notification of the initial video level described in the second embodiment and the logo display region information up to a time t2 in FIG. 13 via the communication signal C1. Following the processing of S301 to S303 in FIG. 10, the routine advances to S401. When notification of the logo display region information is not received before the time t2 in S401, the logo display region is determined to be the entire screen in S402, whereupon a start point (0, 0) and an end point (1919, 1079) of the logo display region (the screen) are set as region parameters. When the notification is received before the time t2, on the other hand, the routine advances to 1403, in which a start point (Xs, Ys) and an end point (Xe, Ye) of the logo display region are set as the region parameters.

Next, in S404 (at the time t2), correction values of the display elements positioned within the logo display region, from among the first correction values selected using the method of the second embodiment, are transferred as the part of the data (the first correction data in the first region).

When transfer of the part or the data is determined to be complete in S405, i.e. at a time t4, the region parameters are set in a region counter 2000 of the multi-value correction calculation unit 1001 shown in FIG. 14 in S406.

The region counter 2000 decodes horizontal and vertical counters, not shown in the drawings, and respective counter outputs upon reception of the synchronization signal T2 from the timing control unit 206, and transfers a region specification signal for specifying a time corresponding to the logo display region and a remaining time to a region selector 2001.

Following S406, correction processing using the part of the data is enabled (S407). More specifically, the region selector 2001 selects the correction values from the interpolation calculation unit 1004 during a logo display region specification period and selects zero during a remaining period. As a result, appropriate correction is applied to the logo display region and the remaining region is forcibly set at the black level.

Next, similar processing to the processing of S205 to S208 in FIG. 1 is performed. As a result, video display on the display panel 200 is begun. More specifically, logo display in only the logo display region is begun following t4

In S408 (at the time t4), a determination is made as to whether or not the logo display region corresponds to the entire region of the screen. If so, the routine advances to S209, and if not, the routine advances to S409.

In S409, correction values (the first correction data of a second region) of the display elements positioned in the region (a second region) other than the logo display region, from among the first correction values selected using the method of the second embodiment, are transferred. Note that there are no particular limitations on the transfer method used in S409. For example, when DMA transfer can be performed efficiently by transferring rectangular regions, the second region may be transferred after being divided into a plurality of rectangular regions.

When it is determined in S410 that transfer of the first correction data of the second region is complete at a time t5, the processing of S209 to S211 is performed. Accordingly, the correction processing is switched to the correction processing using all of the correction data at a time t6, and the display is switched from logo display to broadcast display at a time t7. Note that S209 to S211 are similar to their counterparts in FIG. 1 and therefore description has been omitted.

Hence, in this embodiment, the correction values of the display elements positioned in the logo display region, which is smaller than the entire screen region, are transferred as the part of the data, whereupon correction processing and video display are begun using the part of the data. As a result, the time required to display a video can be shortened even further in comparison with the first and second embodiments.

Note that in this embodiment, the correction values of the display elements positioned in the logo display region from among the first correction values selected using the method of the second embodiment are set as the part of the data, but all of the correction values of the display elements positioned within the logo display region may be set as the part of the data. In this case also, the time required to display a video can be reduced in comparison with the related art.

### Fourth Embodiment

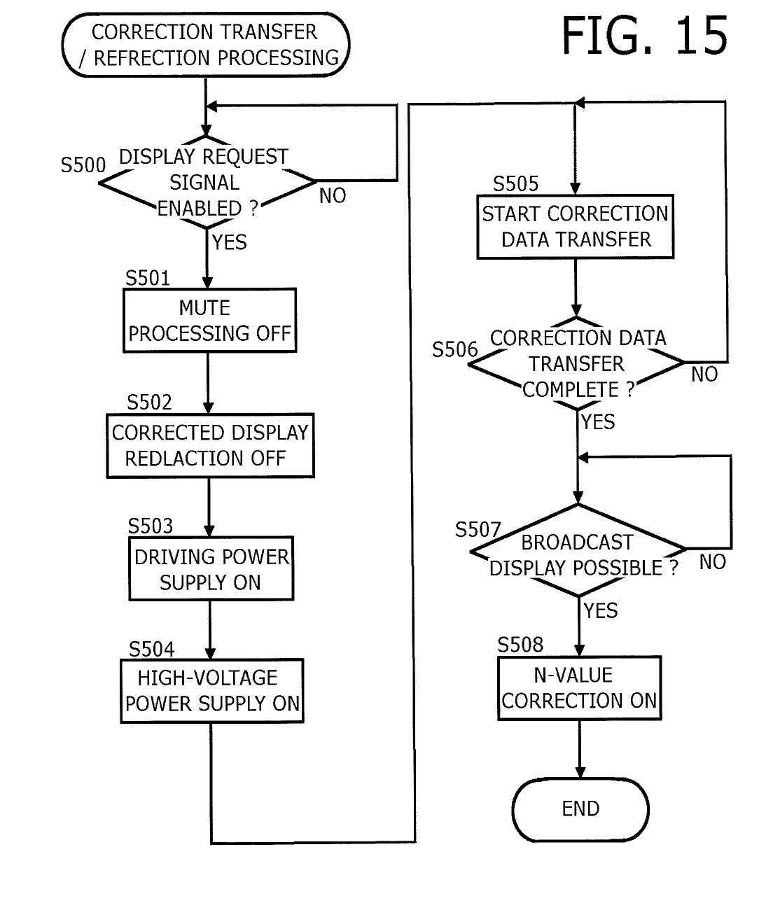

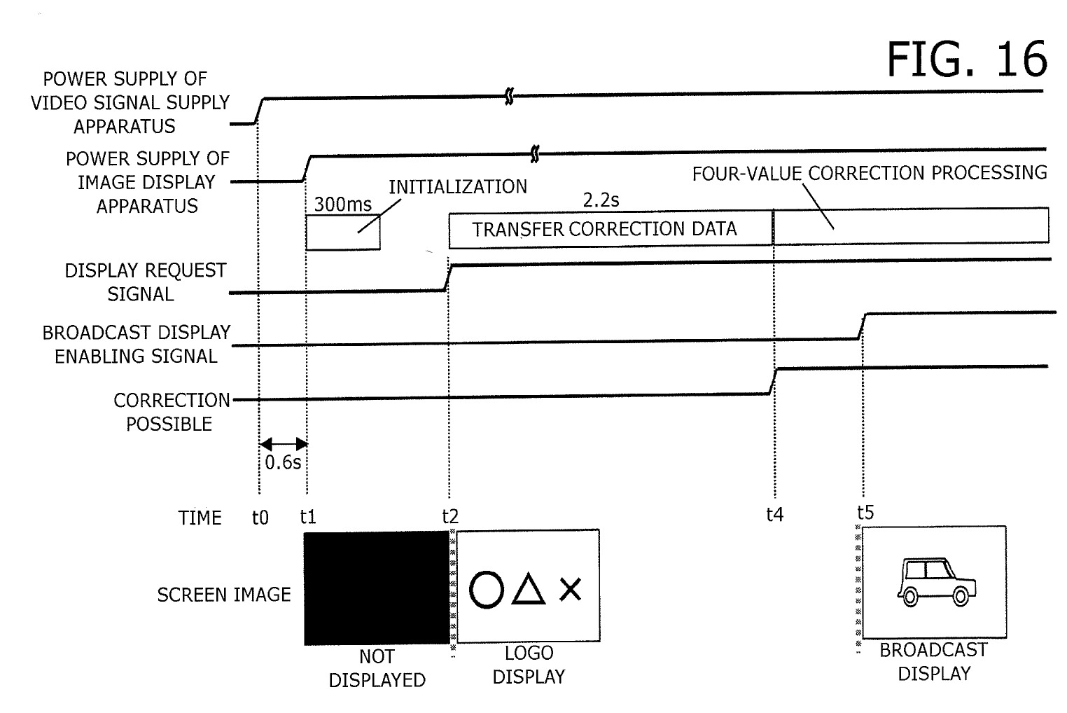

In a fourth embodiment of the present invention, a case in which the display video changes in stages, as shown in FIG. 8B, will be described using FIGS. 15 and 16. According to the constitution (control method) of this embodiment, the time required to display a video can be shortened further in comparison with the third embodiment. Parts that differ from the first embodiment will be described below.

FIG. 15 is a flowchart illustrating features of this embodiment. FIG. 16 is a timing chart showing an example of a startup sequence according to the fourth embodiment. A large difference with the first embodiment is that a predetermined video signal subjected to brightness variation correction in advance is input into the image display apparatus. Further, in addition to the display request signal, the system control unit 207 is notified of a broadcast display enabling signal indicating that broadcast display has become possible via the communication signal C1.

When the display request signal is detected in S500 of FIG. 15 (at a time t2 in FIG. 16), the mute processing is switched. OFF in S501 and corrected display reflection is switched OFF in S502. When corrected display reflection is switched OFF, the correction value applied to the multiplication unit 1005 in FIG. 6 is set forcibly at 1. As a result of this control, the signal S1 (the brightness data) is output as is as the signal S4 (the corrected brightness data).

Then, by starting up the driving power supply in S503 and starting up the high-voltage power supply in S504, video display on the display panel 200 begins. More specifically, a video (logo image) based on the predetermined video signal is displayed. In this embodiment, brightness variation correction is implemented on the predetermined video signal, and therefore a video exhibiting no brightness variation is displayed from the start.

Next, in S505 (at a time t2) transfer of the correction data begins.

When all of the correction data are stored in the volatile memory 1002 and a video signal not subjected to correction processing is input, the multi-value correction calculation unit 1001 begins correction processing using all of the correction data. At the same time, the video displayed on the display panel 200 is switched to a video based on the video signal subjected to the correction processing by the multi-value correction calculation unit 1001. More specifically, the completion of correction data transfer is confirmed in S506 (at a time t4). Then, when the broadcast display enabling signal indicating that broadcast display has become possible is detected in S507 (at a time t5), the correction value applied to the multiplication unit 1005 is switched from 1 to the output of the interpolation calculation unit 1004. As a result, correction processing using all of the correction data is enabled, whereby the video display is switched from logo display to broadcast display.

Hence, in this embodiment, a predetermined video signal that has been subjected to brightness variation correction in advance is input such that when correction data transfer begins, display of a video based on the predetermined video signal is begun on the display panel. As a result, the time required to display the video can be shortened greatly (more specifically, the time required to display a video caused by the correction data transfer time can be substantially eliminated).

Note that in this embodiment, an example in which a predetermined video signal subjected to brightness variation correction is input from the video signal supply apparatus was described, but the video signal may be stored in the image display apparatus in advance. Further, the image display apparatus may generate the video signal. Similar effects are obtained with these constitutions.

In this embodiment, the correction processing using all of the correction data is begun after all, of the correction data have been stored in the volatile memory, but this embodiment is not limited to this constitution, and for example, the correction processing using a part of the data may be begun after a part of the correction data has been stored in the volatile memory, as in the first to third embodiments. Then, following the start of correction data transfer, correction processing using the transferred correction data may be begun.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-021939, filed on Feb. 3, 2010, which is hereby incorporated by reference herein in its entirety.

What is claimed is:

1. An image display apparatus comprising:
a display panel having a plurality of display elements disposed in a matrix form;
a first storage unit that stores correction data used in correction processing for reducing brightness variation among the plurality of display elements;
a second storage unit used as a work memory;
a transfer unit that transfers the correction data from the first storage unit to the second storage unit;
a correction unit that implements the correction processing on an input video signal while referencing the second storage unit; and
a control unit,
wherein the control unit performs control such that when a part of the correction data has been stored in the second storage unit by the transfer unit, interim correction processing using the part of the correction data is started by the correction unit and video display on the display panel is begun, and after a remainder of the correction data has been stored in the second storage unit by the transfer unit, the correction processing performed by the correction unit is switched to correction processing using all of the correction data.

2. The image display apparatus according to claim 1, wherein the correction data are prepared for each of the plurality of display elements,
the correction data for a single display element are constituted by N (where N is an integer of 2 or more) correction values corresponding to N gradation values, and
the correction processing using all of the correction data is processing for converting gradation values of the input video signal using a correction value curve obtained by interpolating the N correction values.

3. The image display apparatus according to claim 2, wherein the part of the correction data is constituted by n (where n is an integer of 1 or more and less than N) correction values from among the N correction values.

4. The image display apparatus according to claim 3, wherein N is an integer of 3 or more,
n is an integer of 2 or more and less than N, and
the interim correction processing is processing for converting the gradation values of the input video signal using a correction value curve obtained by interpolating the n correction values.

5. The image display apparatus according to claim 2, wherein the part of the correction data is constituted by correction values of display elements positioned within a partial region of a screen of the display panel, and
the interim correction processing is processing for correcting only a part of the input video signal displayed in the partial region.

6. The image display apparatus according to claim 3, wherein a predetermined video signal is input into the image display apparatus from a video signal supply apparatus and the video signal supply apparatus notifies the image display apparatus of a representative value of gradation values in the predetermined video signal, and
the control unit cause the transfer unit to transfer, as the part of the correction data, at least n correction values including two correction values that correspond to two gradation values on either side of the representative value, from among the N correction values.

7. The image display apparatus according to claim 3, wherein a predetermined video signal is input into the image display apparatus from a video signal supply apparatus and the video signal supply apparatus notifies the image display apparatus of information indicating n gradation values, and
the control unit cause the transfer unit to transfer, as the part of the correction data, n correction values corresponding to the n gradation values notified by the video signal supply apparatus.

8. The image display apparatus according to claim 5, wherein a predetermined video signal is input into the image display apparatus from a video signal supply apparatus and the video signal supply apparatus notifies the image display apparatus of information indicating a display region of a video based on the video signal, and
the control unit cause the transfer unit to transfer, as the part of the correction data, correction values of display elements positioned within the display region notified by the video signal supply apparatus.

9. An image display apparatus comprising:
a display panel having a plurality of display elements disposed in a matrix form;
a first storage unit that stores correction data used in correction processing for reducing brightness variation among the plurality of display elements;
a second storage unit used as a work memory;
a transfer unit that transfers the correction data from the first storage unit to the second storage unit;
a correction unit that implements the correction processing on an input video signal while referencing the second storage unit; and
a control unit,
wherein the control unit performs control such that when transfer of the correction data begins, display of a video based on a predetermined video signal that has been subjected in advance to the correction processing for reducing the brightness variation is started, and after transfer of the correction data has begun, correction processing using the transferred correction data is started by the correction unit.

10. The image display apparatus according to claim 1, wherein the first storage unit is a non-volatile memory and the second storage unit is a volatile memory.

11. The image display apparatus according to claim 1, wherein the display element is an electron-emitting device.

12. A control method for an image display apparatus including
a display panel having a plurality of display elements disposed in a matrix form;
a first storage unit that stores correction data used in correction processing for reducing brightness variation among the plurality of display elements
a second storage unit used as a work memory;
a transfer unit that transfers the correction data from the first storage unit to the second storage unit; and
a correction unit that implements the correction processing on an input video signal while referencing the second storage unit,
the control method comprising the steps of:
starting interim correction processing using a part of the correction data by the correction unit and starting video display on the display panel when the part of the correction data has been stored in the second storage unit by the transfer unit; and
switching the correction processing performed by the correction unit to correction processing using all of the correction data after a remainder of the correction data has been stored in the second storage unit by the transfer unit.
